(19) United States
(12) Patent Application Publication
(10) Pub. No.: US 2019/0094036 A1
(43) Pub. Date: Mar. 28, 2019

(54) VEHICLE CONTROL DEVICE

(71) Applicant: MAZDA MOTOR CORPORATION, Hiroshima (JP)

(72) Inventors: Takashi OSAKI, Aki-gun (JP); Takayuki MORITANI, Aki-gun (JP); Tetsuya TACHIHATA, Aki-gun (JP); Shoji HARADA, Aki-gun (JP); Ryo SATO, Aki-gun (JP)

(73) Assignee: MAZDA MOTOR CORPORATION, Hiroshima (JP)

(21) Appl. No.: 16/114,641

(22) Filed: Aug. 28, 2018

(30) Foreign Application Priority Data
Sep. 27, 2017 (JP) 2017-185759

(51) Int. Cl. G01C 21/34; G08G 1/01; G08G 1/0967; G08G 1/052

(52) U.S. Cl. CPC G01C 21/3492; G08G 1/0125; G08G 1/012; G08G 1/096716; G08G 1/052; G08G 1/0112

(57) ABSTRACT

Provide a vehicle control device capable of facilitating input manipulation for a setup vehicle speed to be used in a driving support mode. The vehicle control device 100 comprises a control part operable to execute vehicle speed control according to a setup vehicle speed, a manipulation unit 24, and a speed limit recognition part operable to acquire a speed limit, and the manipulation unit 24 comprises a resume switch 24g, and wherein the control part is operable, in response to manipulation of the resume switch 24g during the standby state, to select and store a vehicle speed value as the setup vehicle speed (S22, S29) in different manners between a situation where the setup vehicle speed is currently stored (S20; YES), and a situation where no setup vehicle speed is currently stored (S20; NO).

### TECHNICAL FIELD

The present invention relates to a vehicle control device, and more particularly to a vehicle control device for executing vehicle control using a speed limit assigned to a traveling road.

### BACKGROUND ART

In recent years, various driving support modes have been provided to a driver by a driving support control system equipped on a vehicle. For example, there has been known a driving support mode in which vehicle control is performed to enable a vehicle to follow a preceding vehicle under the condition that a predetermined setup vehicle speed is an upper limit vehicle speed (see the following Patent Document 1). Further, in the Patent Document 1, the driving support mode is configured to detect a speed limit (sign-designated speed) from a speed sign imaged by a camera, and replace a current setup vehicle speed with the detected speed limit after a given time (3 seconds) of the detection. Thus, in the Patent Document 1, upon detection of a speed sign, a speed limit designated by the detected sign (sign-designated speed) is used as a new setup vehicle speed.

A driver can disable switching of a current setup vehicle speed to the sign-designated speed, by manipulate a resume switch provided on a steering wheel, within a given time period after the detection. Generally, the resume switch is a switch for switching the driving support mode from a standby state to an active state. In a case where a current setup vehicle speed is stored in a memory, in response to manipulation of the resume switch, the driving support mode is resumed or restarted using the stored setup vehicle speed.

### CITATION LIST

### Patent Document

Patent Document 1: JP 2012-206594A

### SUMMARY OF INVENTION

### Technical Problem to be Solved

However, in the Patent Document 1, no consideration is made about processing for setting the detected speed limit (sign-designated speed) as the setup vehicle speed, when the driving support mode is in the standby state. Therefore, in the standby state, a driver needs to manually input the detected speed limit as the setup vehicle speed, leading to a problem that it takes a lot of time and effort for the input manipulation.

The present invention has been made in view of solving such problem, and the object thereof is to provide a vehicle control device capable of improving manipulatability and safety during driver's manipulation for inputting a setup vehicle speed to be used in a driving support mode.

### Solution to Technical Problem

In order to achieve the above object, the present invention provides a vehicle control device comprising: a control part operable to execute vehicle speed control for a vehicle according to a setup vehicle speed being stored, during execution of a driving support mode; a manipulation unit manipulatable by a driver; and a speed limit recognition part operable to acquire a speed limit assigned to a traveling road, wherein the driving support mode includes an active state in which the vehicle speed control is executed, and a standby state in which the vehicle speed control is temporarily disabled, wherein the manipulation unit comprises a resume switch, and wherein the control part is operable, in response to manipulation of the resume switch during the standby state, to select and store a vehicle speed value as the setup vehicle speed in different manners between a situation where the setup vehicle speed is currently stored and a situation where no setup vehicle speed is currently stored.

In the vehicle control device of the present invention having the above feature, when a driver manipulates the resume switch during the standby state of the driving support mode, processing is executed in different manners depending on whether or not the setup vehicle speed has already been stored, so as to set an appropriate value as the setup vehicle speed. Therefore, the vehicle control device of present invention makes it possible to improve safety and manipulatability by the driver during returning to the active state.

Preferably, in the vehicle control device of the present invention, the control part is operable, in response to manipulation of the resume switch during the standby state, to maintain the currently-stored setup vehicle speed in the situation where the setup vehicle speed is currently stored, and store the speed limit acquired by the speed limit recognition part as the setup vehicle speed in the situation where no setup vehicle speed is currently stored.

According to this feature, when the resume switch is manipulated during the standby state, either one of the currently-stored or existing setup vehicle speed recognized by the driver and the speed limit assigned to the traveling road is set as the setup vehicle speed. Therefore, it becomes possible to improve safety and manipulatability by the driver during returning to the active state.

Preferably, in the above vehicle control device of the present invention, when the control part operates to maintain the currently-stored setup vehicle speed in response to manipulation of the resume switch during the standby state, the control part is further operable to switch the driving support mode from the standby state to the active state.

According to this feature, the driver can use the resume switch to switch the driving support mode from the standby state to the active state, as with conventional devices.

Preferably, in the above vehicle control device of the present invention, when the control part operates to store the speed limit acquired by the speed limit recognition part as the setup vehicle speed in response to manipulation of the resume switch during the standby state, the control part is further operable to maintain the driving support mode in the standby state.

According to this feature, when the resume switch is manipulated during the standby state and in the situation where no setup vehicle speed has yet been stored, setting of the setup vehicle speed is first performed using the speed limit. Then, the driver can manipulates the resume switch again to return the driving support mode to the active state.

Preferably, in the above vehicle control device of the present invention, when the control part operates to store the speed limit acquired by the speed limit recognition part as the setup vehicle speed in response to manipulation of the resume switch during the standby state, the control part is operable to switch the driving support mode from the standby state to the active state in response to re-manipulation of the resume switch.

According to this feature, even in the situation where no setup vehicle speed has yet been stored, the driver can manipulate the resume switch twice at a maximum to return the driving support mode to the active state.

Preferably, in the vehicle control device of the present invention, the manipulation unit comprises a cancel switch for switching the driving support mode from the active state to the standby state during execution of the driving support mode, and wherein the control part is operable to store the speed limit acquired by the speed limit recognition part as the setup vehicle speed in response to manipulation of the cancel switch during the active state.

According to this feature, the driver can manipulate the cancel switch to switch the driving support mode from the active state to the standby state. In this process, the speed limit assigned to the traveling road is stored as the setup vehicle speed. Thus, when the driving support mode is returned to the active state, the vehicle speed control in the driving support mode is executed while using the speed limit assigned to the traveling road as the setup vehicle speed. Therefore, according to this feature, it becomes possible to improve safety and manipulatability by the driver, during returning to the active state, without any need to re-set the setup vehicle speed in conformity to the traveling road.

Preferably, in the above vehicle control device of the present invention, the manipulation unit comprises a vehicle speed setting switch for setting the setup vehicle speed, and wherein the control part is operable to switch the driving support mode from the standby state to the active state in response to manipulation of the vehicle speed setting switch until elapse of a given time period after the speed limit acquired by the speed limit recognition part is stored as the setup vehicle speed.

According to this feature, until the elapse of the given time period after the driving support mode is switched from the active state to the standby state by the manipulation of the cancel switch (or after the acquired speed limit is stored as the setup vehicle speed), the vehicle speed setting switch can be used for returning the driving support mode to the active state as with the resume switch, instead of for setting the setup vehicle speed.

Preferably, in the above vehicle control device of the present invention, the control part is operable to change the currently-stored setup vehicle speed in response to manipulation of the vehicle speed setting switch after the elapse of the given time period.

According to this feature, after the elapse of the given time, the vehicle speed setting switch can be used for achieving an original function thereof, i.e., a function of setting the setup vehicle speed.

Preferably, in the vehicle control device of the present invention, the control part is operable to switch the driving support mode to the active state so as to execute the vehicle speed control using the setup vehicle speed currently stored in response to manipulation of the resume switch during the standby state, and wherein the control part is operable to store the speed limit acquired by the speed limit recognition part as the setup vehicle speed in response to manipulation of the resume switch during the active state, and to store the speed limit acquired by the speed limit recognition part as the setup vehicle speed in response to manipulation of the resume switch during the standby state in a situation where no setup vehicle speed is currently stored.

According to this feature, when the driver manipulates the resume switch during the standby state of the driving support mode, the driving support mode is resumed or restarted (returned to the active state), while using the currently-stored setup vehicle speed, as with conventional systems. Further, according to this feature, depending on actual conditions, different controls are executed in response to manipulation of the resume switch. Specifically, during the active state, in place of the currently-stored setup vehicle speed, the speed limit is used as the setup vehicle speed, and the active state is maintained. Further, during the standby state and in the situation where no setup vehicle speed has yet been stored, the speed limit is stored as the setup vehicle speed. As above, according to this feature, depending on an activation state (the active or standby state) of the driving support mode, and the presence or absence of the setup vehicle speed, the driver can easily set the setup vehicle speed in conformity to the speed limit assigned to the traveling road, by means of the resume switch. This makes it possible to improve safety and manipulatability by the driver, during the driving support mode.

Preferably, in the above vehicle control device of the present invention, the control part is operable, when the vehicle is stopped by the vehicle speed control in the active state, to maintain the stopped state until the resume switch is manipulated, and to permit the vehicle to be started in response to the manipulation of the resume switch.

According to this feature, when the vehicle is automatically stopped by the vehicle speed control in the driving support mode, the vehicle is allowed to be started in response to the manipulation of the resume switch indicative of driver's intention to start the vehicle.

### Effect of Invention

The vehicle control device of the present invention makes it possible to improve manipulatability and safety during driver's manipulation for inputting the setup vehicle speed to be used in the driving support mode.

### BRIEF DESCRIPTION OF DRAWINGS

FIG. 1 is a block diagram of a vehicle control device according to one embodiment of the present invention.

FIG. 2 is an explanatory diagram of a manipulation unit in the vehicle control device according to this embodiment.

FIG. 3 is an explanatory diagram of vehicle control upon acquisition of a speed limit, in the vehicle control device according to this embodiment.

FIG. 4A and FIG. 4B are explanatory diagrams of vehicle control by manipulation of a resume switch (during a standby state; data stored in a memory), in the vehicle control device according to this embodiment.

FIG. 5A and FIG. 5B are explanatory diagrams of vehicle control by manipulation of the resume switch (during the standby state; no data stored in the memory), in the vehicle control device according to this embodiment.

FIG. 6A and FIG. 6B are explanatory diagrams of vehicle control by manipulation of the resume switch (during an active state), in the vehicle control device according to this embodiment.

FIG. 7A and FIG. 7B are explanatory diagrams of vehicle control by manipulation of a cancel switch, in the vehicle control device according to this embodiment.

FIG. 8 is a part of a processing flow of vehicle control processing in the vehicle control device according to this embodiment.

FIG. 9 is a remaining part of the processing flow of the vehicle control processing in the vehicle control device according to this embodiment.

### DESCRIPTION OF EMBODIMENTS

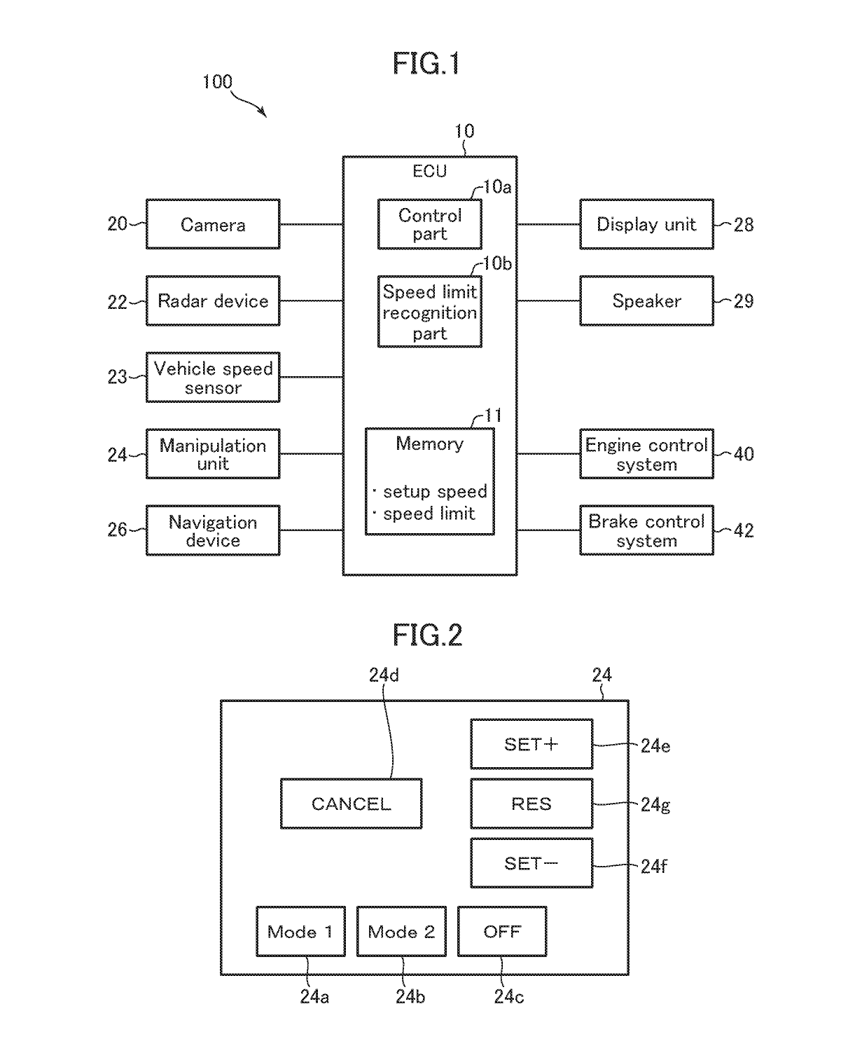

With reference to the accompanying drawings, a vehicle control device according to one embodiment of the present invention will now be described. First of all, with reference to FIGS. 1 and 2, the configuration of the vehicle control device according to this embodiment will be described. FIG. 1 is a block diagram of the vehicle control device, and FIG. 2 is an explanatory diagram of a manipulation unit in the vehicle control device.

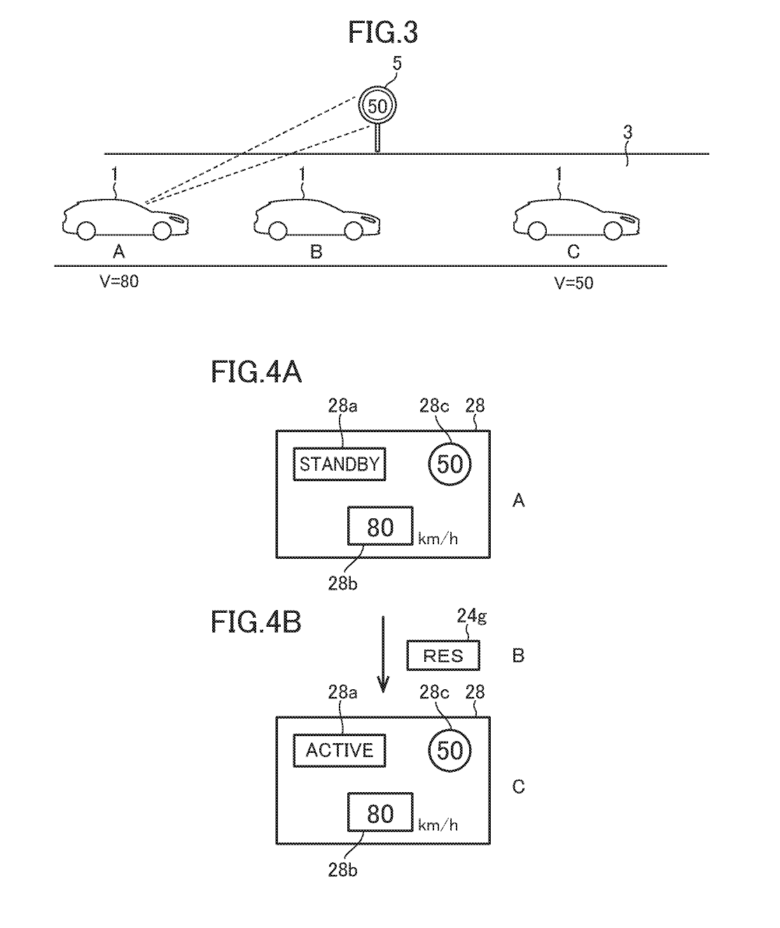

The vehicle control device 100 according to this embodiment is equipped on a vehicle 1 (see FIG. 3), and configured to execute given driving support control, depending on a driving support mode selected by a driver.

In this embodiment, the driving support mode includes a preceding vehicle following sub-mode, and a vehicle speed limiting sub-mode. The preceding vehicle following sub-mode is a mode for executing vehicle speed control and steering control of the vehicle 1, so as to execute vehicle control to enable the vehicle 1 to travel while maintaining a setup vehicle speed when there is no preceding vehicle, and to enable the vehicle 1 to follow the preceding vehicle under the condition that a setup vehicle speed serves as an upper limit vehicle speed when there is a preceding vehicle. In this vehicle speed control, the vehicle control device 100 is operable to automatically control an engine power output through an engine control system 40, and automatically control a braking force through a brake control system 42. Further, in the steering control, the vehicle control device 100 is operable to automatically control a steering angle by a steering wheel through a steering control system.

The vehicle speed limiting sub-mode is a mode for executing the vehicle control (vehicle speed control) so as to prevent the vehicle speed of the vehicle 1 from exceeding a setup vehicle speed. In this sub-mode, the engine power output is controlled according to the amount of depression of an accelerator pedal caused by manipulation of the accelerator pedal by a driver. However, when the vehicle speed of the vehicle 1 exceeds the setup vehicle speed, the vehicle control device 100 is operable to limit the vehicle speed of the vehicle 1 to the setup vehicle speed, irrespective of the depression amount of the accelerator pedal. In this case, the vehicle control device 100 is operable to reduce the engine power output through the engine control system 40, and, optionally, as needed, apply the braking force through the brake control system 42.

As depicted in FIG. 1, the vehicle control device 100 comprises an electronic control unit (ECU) 10, various sensors/input-output units, and given vehicle systems. The sensors/input-output units include: an external imaging camera 20; a radar device 22 for detecting any second vehicles located forward and rearward of the vehicle 1; a vehicle speed sensor 23 for detecting the vehicle speed of the vehicle 1; a manipulation unit 24 for allowing user input regarding the driving support control; a navigation device 26; a display unit 28 for presenting information to a driver; a speaker 29; and other sensors. The vehicle systems include the engine control system 40 and the brake control system 42.

The ECU 10 comprises a computer comprising a CPU, a memory 11 for storing therein various programs and data, and an input-output device, etc. The ECU 10 includes various functions, including functions as a control part 10a and a speed limit recognition part 10b, for example.

The ECU 10 (control part 10a) is operable to display given information on the display unit 28 based on an externally received signal, and output request signals, respectively, to the vehicle systems (the engine control system 40, the brake control system 42, etc.) to execute vehicle control processing during an activated state of the driving support mode, such as the preceding vehicle following sub-mode and the vehicle speed limiting sub-mode. The data stored or to be stored in the memory 11 includes a setup vehicle speed to be used for the vehicle speed control during execution of the driving support mode, and a speed limit acquired by the speed limit recognition part 10b.

The ECU 10 (control part 10a) is operable to monitor a current value of the vehicle speed of the vehicle 1 detected by the vehicle speed sensor 23, and to execute overspeed alarm processing for generating an overspeed alarm from the speaker 29 (alarm unit) when the current vehicle speed exceeds a threshold speed. In addition to the alarm from the speaker 29, the overspeed alarm may include a visual display on the navigation device 26, the display unit 28, or the like.

Further, the ECU 10 (speed limit recognition part 10b) is operable to execute speed limit recognition processing for acquiring a speed limit (sign-designated speed) designated by a speed sign in the image data captured by the camera 20 by analyzing the image data. The camera 20 is operable to capture an image of a forward field of view of the vehicle 1, and transmit data about the captured image to the ECU 10. Here, the speed limit recognition part 10b may include the camera 20, as one component thereof.

The radar device 22 is operable to transmit radio waves (transmission waves) toward forward and rearward sides of the vehicle 1, and receive resulting reflected waves. Then, based on the transmission waves and the reflected waves, the radar device 22 is operable to output a signal containing measurement data about an inter-vehicle distance between the vehicle 1 and the second vehicle existing forward or rearward of the vehicle 1, and measurement data about a relative speed with respect to each of the second vehicles. Here, in place of or in addition to the radar device 22, another type of sensor such as a laser radar or a sonar may be used.

The manipulation unit 24 is installed to the steering wheel of the vehicle 1, and provided with a plurality of switches. As depicted in FIG. 2, the manipulation unit 24 comprises: two ON switches 24a, 24b each serving as an activation switch for a respective one of the driving support sub-modes; an OFF switch 24c serving as a stop switch; a cancel switch 24d; two vehicle speed setting switches 24e, 24f; and a resume switch 24g.

The preceding vehicle following sub-mode can be activated by manipulating (pushing down) the ON switch 24a. Further, the vehicle speed limiting sub-mode can be activated by manipulating the ON switch 24b. The activated state of each of the driving support sub-modes includes an active state and a standby state. In the active state, control (vehicle speed control) of changing a vehicle behavior through the engine control system 40 and/or the brake control system 42 is executed. The standby state is a state in which the vehicle behavior changing control is temporarily disabled.

By manipulating the OFF switch 24c, a currently-activated one of the driving support sub-modes can be deactivated, irrespective of whether it is in the active state or in the standby state. While the setup vehicle speed stored in the memory 11 of the ECU 10 is used during the activated state of the selected driving support sub-mode, the setup vehicle speed stored in the memory 11 is cleared (erased) by manipulating the OFF switch 24c.

By manipulating the cancel switch 24d, the currently-activated driving support sub-mode is switched from the active state to the standby state.

The setup vehicle speed can be increased from a current value thereof by manipulating the vehicle speed setting switches 24e. Further, the setup vehicle speed can be reduced from a current value thereof by manipulating the vehicle speed setting switches 24f. Upon input of the setup vehicle speed by a driver, the input setup vehicle speed is stored in the memory 11 of the ECU 10. For example, a driver can press one of the ON switches 24a, 24b, and then press one of the vehicle speed setting switches 24e, 24f to thereby input a current value of the vehicle speed of the vehicle 1 as the setup vehicle speed. Further, after storing the setup vehicle speed in the memory 11 in the above manner, the driver can manipulate one of the vehicle speed setting switches 24e, 24f so as to increase or decrease the setup vehicle speed.

As a basic manipulation function, the resume switch 24g is used such that it is manipulated to restart or resume the driving support sub-mode (to the active state), using the setup vehicle speed stored in the memory 11 of the ECU 10 when the currently-activated driving support sub-mode is in the standby state.

The navigation device 26 is operable to acquire a current position of the vehicle 1 by using the GPS or the like, and specify the position of the vehicle 1 on a map, based on stored map information or map information from an external source. Further, the navigation device 26 is operable to acquire a speed limit (sign-designated speed) assigned to a traveling road along which the vehicle 1 is traveling based on the current position on the map. Therefore, the navigation device 26 may be used as the speed limit recognition part.

The display unit 28 is installed to an instrument panel or the like, and comprises an activation state display field 28a, a setup vehicle speed display field 28b, and a speed limit display field 28c (see FIG. 4A). Although only one activation state display field 28a is depicted in FIG. 4A for the sake of facilitating understanding, it is to be understood that a plurality of activation state display fields may be provided correspondingly to respective ones of a plurality of driving support modes.

The activation state display field 28a is a display field for displaying the activation state of a selected one of the driving support sub-modes. On the activation state display field 28a, the execution state of the selected driving support sub-mode is displayed in the form of one of “BLANK (OFF)”, “ACTIVE” and “STANDBY”.

The setup vehicle speed display field 28b is a display field for displaying the setup vehicle speed (e.g., “80”) stored in the memory 11 of the ECU 10. Here, when no setup vehicle speed is stored in the memory 11, “BLANK (---)” is displayed on the setup vehicle speed display field 28b.

The speed limit display field 28c is a display field for displaying the acquired speed limit (e.g., “50”). Here, when no speed limit is acquired, “BLANK” is displayed on the speed limit display field 28c.

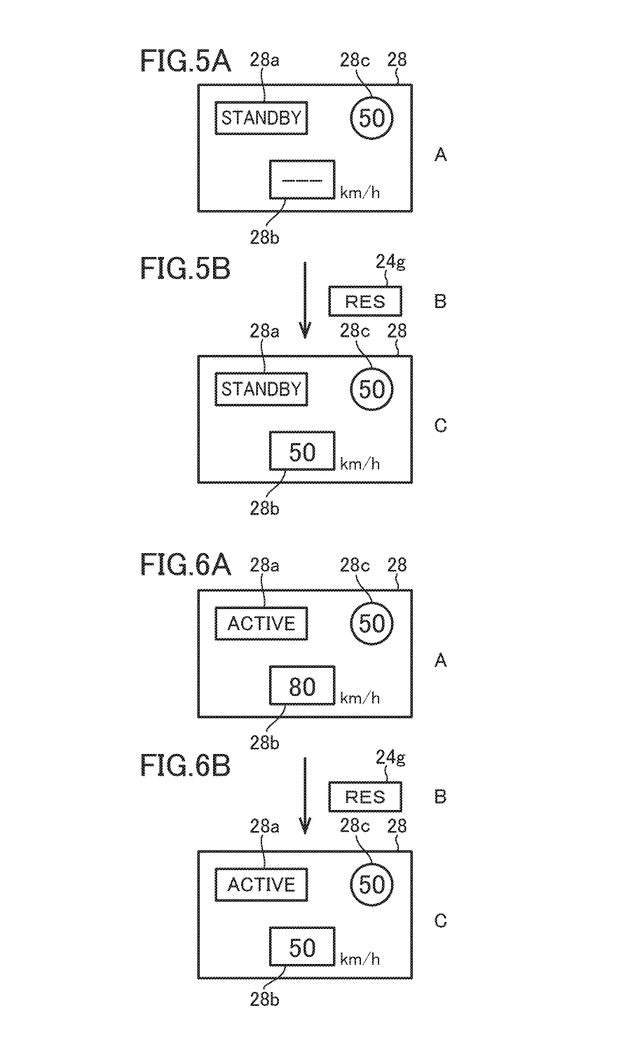

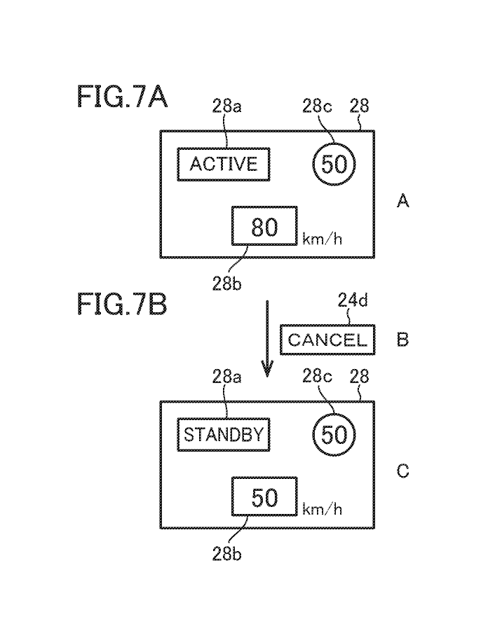

Next, with reference to FIGS. 3 to 7, various manipulations with the manipulation unit in the vehicle control device according to this embodiment will be described. FIG. 3 is an explanatory diagram of vehicle control upon acquisition of a speed limit. FIG. 4A and FIG. 4B are explanatory diagrams of vehicle control by manipulation of the resume switch (during the standby state; data stored in the memory). FIG. 5A and FIG. 5B are explanatory diagrams of vehicle control by manipulation of the resume switch (during the standby state; no data stored in the memory). FIG. 6A and FIG. 6B are explanatory diagrams of vehicle control by manipulation of the resume switch (during the active state). FIG. 7A and FIG. 7B are explanatory diagrams of vehicle control by manipulation of the cancel switch.

FIG. 3 depicts a state in which the vehicle 1 is traveling at a vehicle speed of 80 km/h (V=80), along a traveling road 3 assigned with a speed limit of 80 km/h. The vehicle 1 detects a speed sign 5 (speed limit “50 km/h”) provided beside the traveling road 3, at a position A before the speed sign 5. Subsequently, the vehicle 1 passes beside the speed sign 5 (passes through a position B), and enters a zone assigned with a speed limit of 50 km/h (at a position C). As the driving support mode, one of the preceding vehicle following sub-mode and the vehicle speed limiting sub-mode is selected. During the vehicle speed control in the preceding vehicle following sub-mode, an automatic increase and an automatic reduction in vehicle speed of the vehicle 1 are executed. On the other hand, during the vehicle speed control in the vehicle speed limiting sub-mode, only an automatic reduction in vehicle speed of the vehicle 1 is executed, wherein the vehicle speed of the vehicle 1 can be increased according to manipulation of the accelerator pedal by a driver.

In the example depicted in FIG. 4, at the position A, information is displayed on the display unit 28 of the vehicle 1, as depicted in FIG. 4A. At this time, the selected driving support sub-mode is in the standby state (“STANDBY”), and the setup vehicle speed is 80 km/h (“80 km/h”). Further, the speed limit is 50 km/h (“50”) as the speed sign 5 has been detected.

When the driver manipulates (presses) the resume switch 24g at the position B, the operational function of the resume switch 24g is executed (in the same manner as conventionally done). That is, as depicted in FIG. 4B, the activation state of the selected driving support sub-mode is switched from the standby state to the active state, while the setup vehicle speed is maintained at 80 km/h. Thus, “ACTIVE” is displayed on the activation state display field 28a (at the position C). The vehicle control device 100 executes the vehicle speed control through the engine control system 40 and/or the brake control system 42, using the setup vehicle speed as a target vehicle speed. In this example, the vehicle speed of the vehicle 1 is maintained at 80 km/h. As above, a conventional part of the operational function of the resume switch is not changed, so that the driver can manipulate the resume switch in a conventional manner without any erroneous manipulation.

In the example depicted in FIG. 5, at the position A, information is displayed on the display unit 28 of the vehicle 1, as depicted in FIG. 5A. At this time, the selected driving support sub-mode is in the standby state (“STANDBY”), and the speed limit is 50 km/h (“50”). However, no setup vehicle speed has yet been stored in the memory 11, so that “BLANK (---)” is displayed on the setup vehicle speed display field 28b.

When the driver manipulates (presses) the resume switch 24g at the position B, the speed limit (50 km/h) is stored as a setup vehicle speed in the memory 11, and “50” (50 km/h) is displayed on the setup vehicle speed display field 28b, as depicted in FIG. 5B (at the position C). That is, in a situation where no setup vehicle speed has yet been stored in the memory 11 during the standby state, the driver can manipulate the resume switch 24g to set the speed limit as the setup vehicle speed. However, the activation state of the selected driving support sub-mode is still maintained in the standby state. When the driver wants to set the selected driving support sub-mode to the active state, he/she has only to manipulate the resume switch 24g again, as described with reference to FIG. 4A and FIG. 4B.

In conventional vehicle control devices, even if a resume switch is manipulated in the situation as depicted in FIG. 5A, such a manipulation ends up becoming ineffective. On the other hand, in this embodiment, by manipulating the resume switch 24g, the driver can input the speed limit as the setup vehicle speed, in a simple manner. Therefore, there is no need to manipulate one or more of the vehicle speed setting switches 24e, 24f as in the conventional vehicle control devices, so that it becomes possible to simplify the manipulation.

In the example depicted in FIG. 6A and FIG. 6B, at the position A, information is displayed on the display unit 28 of the vehicle 1, as depicted in FIG. 6A. At this time, the selected driving support sub-mode is in the active state (“ACTIVE”), and the setup vehicle speed and the speed limit are, respectively, 80 km/h (“80 km/h”) and 50 km/h (“50”).

When the driver manipulates (presses) the resume switch 24g at the position B, the setup vehicle speed is replaced with the speed limit (50 km/h), and “50 km/h” is displayed on the setup vehicle speed display field 28b, as depicted in FIG. 6B (at the position C). That is, during the active state, the driver can manipulate the resume switch 24g to newly set the speed limit as the setup vehicle speed. The vehicle control device 100 executes the vehicle speed control through the engine control system 40 and/or the brake control system 42, using the newly-set setup vehicle speed as a target vehicle speed. In this example, the vehicle speed of the vehicle 1 is reduced from 80 km/h to 50 km/h.

As above, in addition to the conventional operational function (function of switching the activation state of the selected driving support sub-mode from the standby state to the active state, using the setup vehicle speed displayed on the setup vehicle speed display field 28b), the resume switch 24g has another operational function (function of rewriting the setup vehicle speed with the speed limit during the active state). Therefore, through the use of an existing resume switch 24g, the driver can perform the rewriting operation in a simple manner, without providing any additional switch to the manipulation unit 28.

In the example depicted in FIG. 7A and FIG. 7B, at the position A, information is displayed on the display unit 28 of the vehicle 1, as depicted in FIG. 7A. At this time, the selected driving support sub-mode is in the active state (“ACTIVE”), and the setup vehicle speed and the speed limit are, respectively, 80 km/h (“80 km/h”) and 50 km/h (“50”).

When the driver manipulates (presses) the cancel switch 24d at the position B, the selected driving support sub-mode is switched from the active state to the standby state, so that “STANDBY” is displayed on the activation state display field 28a, as depicted in FIG. 7B (at the position C). Further, in this embodiment, the setup vehicle speed is replaced with the speed limit (50 km/h), and “50 km/h” is displayed on the setup vehicle speed display field 28b. As a result that the selected driving support sub-mode is switched to the standby state, the vehicle control device 100 does not execute the vehicle speed control. In this case, the driver will reduce the vehicle speed of the vehicle 1 from 80 km/h to 50 km/h, by manipulating a brake pedal or by means of an engine brake.

As above, in addition to the conventional operational function (function of switching the activation state of the selected driving support sub-mode from the active state to the standby state), the cancel switch 24d has another operational function (function of rewriting the setup vehicle speed with the speed limit). Therefore, when restarting the selected driving support sub-mode, the setup vehicle speed has already been set to the speed limit, so that the driver becomes free from the need to re-input the setup vehicle speed during restart of the selected driving support sub-mode.

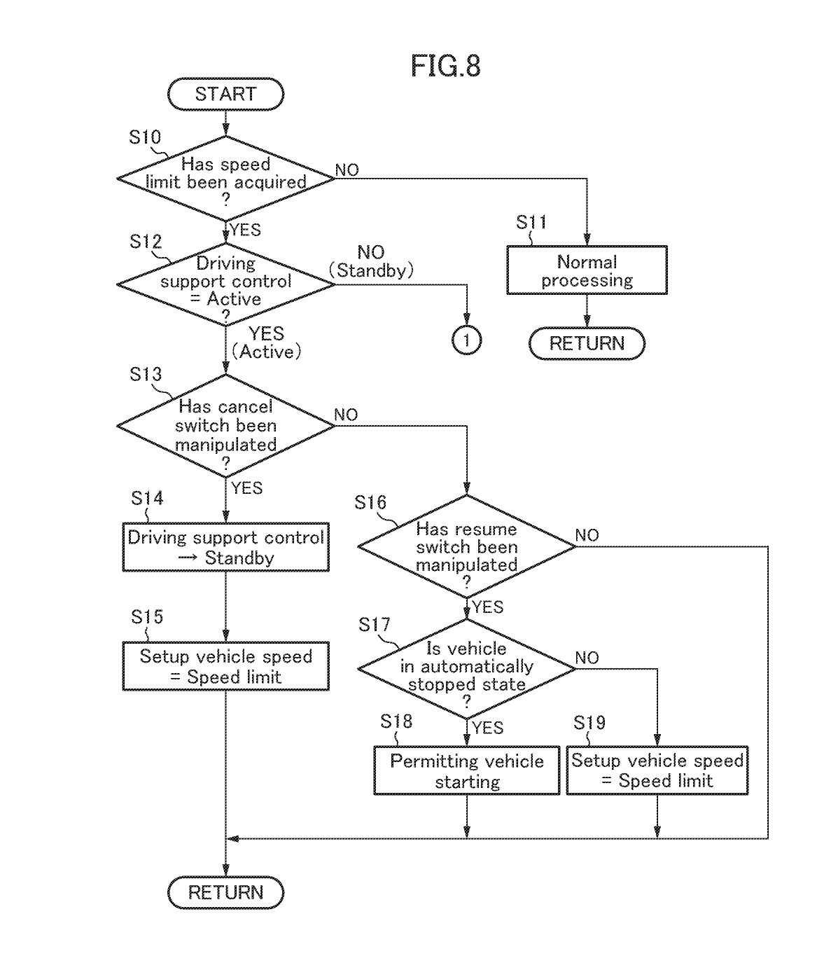

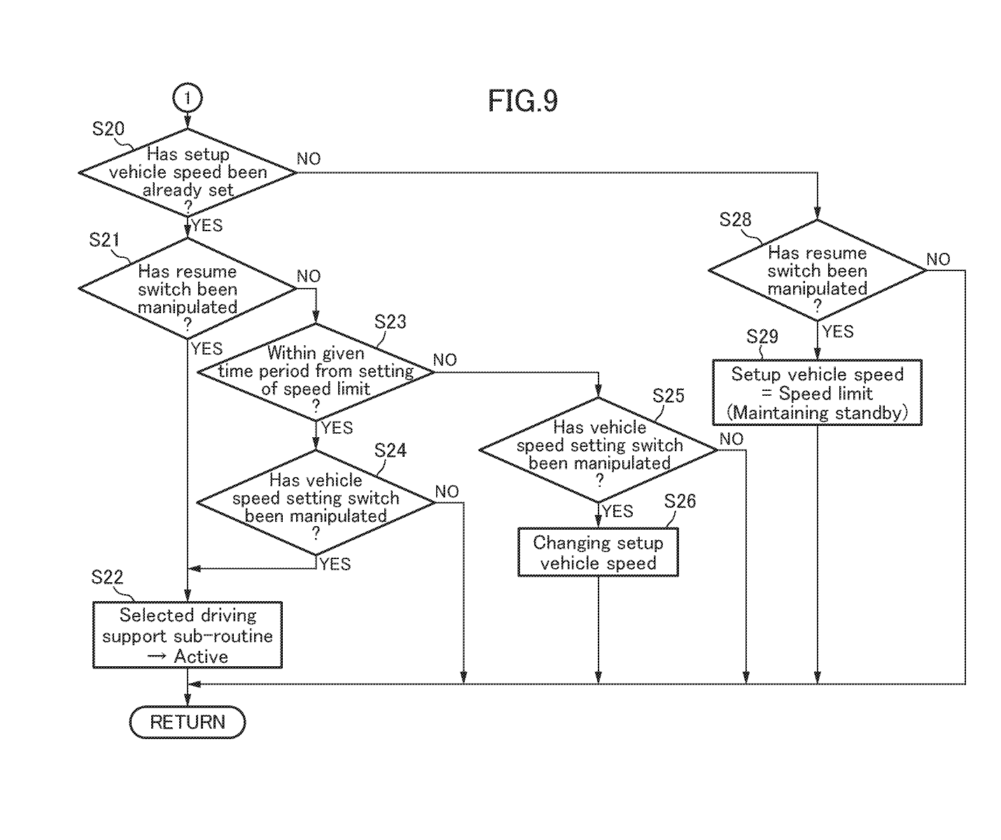

Next, with reference to FIG. 8 and FIG. 9, the flow of the vehicle control processing during the driving support mode, in the vehicle control device according to this embodiment will be described. FIG. 8 and FIG. 9 are a processing flow of the vehicle control processing.

The ECU 10 (control part 10a) repeatedly executes the process flow in FIG. 8 and FIG. 9 at given time intervals. Further, the ECU 10 (speed limit recognition part 10b) executes the speed limit recognition processing by a different processing routine, and stores the recognized speed limit in the memory 11.

Upon start of the vehicle control processing, the ECU 10 operates to determine whether or not a speed limit (sign-designated speed) has been acquired (S10). If no speed limit has yet been stored in the memory 11 (S10; NO), the ECU 10 executes normal processing using no speed limit (S11), and then terminates the processing. On the other hand, if a speed limit is currently stored in the memory 11 (S10; YES), the ECU 10 operates to determine whether a selected one of the driving support sub-modes is in the active state or in the standby state (S12).

If the selected driving support sub-mode is in the active state (S12; YES), the ECU 10 operates to determine whether the cancel switch 24d has been manipulated (S13). If the cancel switch 24d has been manipulated (S13; YES), the ECU 10 operates to switch the selected driving support sub-mode from the active state to the standby state (S14), and rewrite the setup vehicle speed in the memory with the speed limit (S15), and then terminates the processing. The steps S12 to S15 correspond to the example in FIG. 7A and FIG. 7B.

On the other hand, if the cancel switch 24d has not yet been manipulated (S13 NO), the ECU 10 operates to determine whether or not the resume switch 24g has been manipulated (S16). If the resume switch 24g has been manipulated (S16; YES), the ECU 10 operates to determine whether or not the vehicle 1 is in an automatically stopped state (S17).

Here, the automatically stopped state means a state in which the vehicle 1 is stopped during the preceding vehicle following sub-mode because a preceding vehicle located forward of the vehicle 1 is stopped. During the automatically stopped state, the ECU 10 operates to output a request signal to the engine control system 40 and the brake control system 42 of the vehicle 1 so as to cause the vehicle 1 to be maintained in the stopped state.

If the resume switch 24g has been manipulated in a situation where the selected driving support sub-mode is in the active state and the vehicle 1 is not in the automatically stopped state (S17; NO), the ECU 10 operates to rewrite the setup vehicle speed in the memory 11 with the speed limit (S19), and then terminates the processing. The steps S12 to S19 correspond to the example in FIG. 6A and FIG. 6B.

On the other hand, if the resume switch 24g has been manipulated in a situation where the selected driving support sub-mode is in the active state and the vehicle 1 is in the automatically stopped state (S17; YES), the ECU 10 operates to release the stopped state of the vehicle 1 to permit starting of the vehicle 1 (S18), and then terminates the processing. In this process, in place of the request signal for causing the vehicle 1 to be maintained in the stopped state, the ECU 10 operates to output a request signal to the engine control system 40 (and the brake control system 42) so as to cause the vehicle 1 to follow the preceding vehicle. Thus, the selected driving support sub-mode (preceding vehicle following sub-mode) is restarted.

In a situation where, in the automatically stopped state, the preceding vehicle stopped once is started, the ECU 10 may be configured to enable the vehicle 1 to be started so as to automatically follow the preceding vehicle. However, in this embodiment, the ECU 10 is configured to permit the vehicle 1 to be started only after a driver of the vehicle 1 being in the automatically stopped state recognizes starting of the preceding vehicle (i.e., only after the driver manipulates the resume switch 24g) in order to improve safety.

On the other hand, if the selected driving support sub-mode is in the standby state (S12; NO), the ECU 10 operates to determine whether a setup vehicle speed is currently stored in the memory 11 (S20). Then, if a setup vehicle speed is currently stored (S20; YES), the ECU 10 operates to determine whether the resume switch 24g has been manipulated (S21). If the resume switch 24g has been manipulated in a situation where the selected driving support sub-mode is in the standby state and a setup vehicle speed is currently stored in the memory 11 (S21; YES), the ECU 10 operates to switch the selected driving support sub-mode from the standby state to the active state, while maintaining the setup vehicle speed currently stored in the memory 11 (S22), and then terminates the processing. The steps S12 to S22 correspond to the example in FIG. 4A and FIG. 4B.

On the other hand, if the resume switch 24g has not yet been manipulated (S21; NO), the ECU 10 operates to determine whether or not an elapsed time after the setup vehicle speed is rewritten with the speed limit (S15) by the manipulation of the cancel switch 24d (S13) falls within a given time period (e.g., 3 to 10 seconds) (S23). If the elapsed time falls within the given time period (S23; YES), the ECU 10 operates to determine whether or not one of the vehicle speed setting switches 24e, 24f has been manipulated (S24).

If one of the vehicle speed setting switches has been manipulated within the given time period from the manipulation of the cancel switch 24d (S24; YES), the ECU 10 operates to switch the selected driving support sub-mode from the standby state to the active state (S22), in the same manner as that when the resume switch 24g has been manipulated (S21), and then terminates the processing.

In this embodiment, when the driver wants to return the selected driving support sub-mode to the active state after manipulating the cancel switch 24d to switch the selected driving support sub-mode to the standby once, he/she has only to manipulate the resume switch 24g. Then, at the time of returning to the active state, the selected driving support sub-mode can be resumed or restarted in the state where the setup vehicle speed is set by the speed limit. Further, in this embodiment, as long as the elapsed time falls within the given time period, each of the vehicle speed setting switches 24e, 24f can be used to return the selected driving support sub-mode to the active state, as well as the resume switch 24g.

On the other hand, after the elapsed time exceeds the given time period (S23; NO), each of the vehicle speed setting switches 24e, 24f is used to fulfill a normal operational function. Specifically, upon manipulation of one of the vehicle speed setting switches 24e, 24f (S25; YES), the ECU 10 operates to change the setup vehicle speed stored in the memory 11 according to manipulation of the one of the vehicle speed setting switches 24e, 24f (S26), and then terminates the processing.

On the other hand, if no setup vehicle speed is stored in the memory (S20; NO), the ECU 10 operates to determine whether or not the resume switch 24g has been manipulated (S28). If the resume switch 24g has been manipulated in a situation where the selected driving support sub-mode is in the standby state and no setup vehicle speed has yet been stored in the memory 11 (S28; YES), the ECU 10 operates to overwrite a setup vehicle speed by the speed limit in the memory 11 (S29), and then terminates the processing. In this process, the selected driving support mode is maintained in the standby state. The steps S12 to S29 correspond to the example in FIG. 5A and FIG. 5B.

Next, functions of the vehicle control device according to this embodiment will be described.

The vehicle control device 100 according to this embodiment comprises: a control part (ECU 10) operable to execute vehicle speed control for a vehicle 1 according to a setup vehicle speed being stored, during execution of a driving support mode; a manipulation unit 24 manipulatable by a driver; and a speed limit recognition part (ECU 10, navigation device 26) operable to acquire a speed limit assigned to a traveling road 3, wherein the driving support mode includes an active state in which the vehicle speed control is executed, and a standby state in which the vehicle speed control is temporarily disabled, and the manipulation unit 24 comprises a resume switch 24g, and wherein, in response to manipulation of the resume switch 24g (S21, S28) during the standby state, the control part (ECU 10) is operable to select and store a vehicle speed value as the setup vehicle speed in different manners between a situation where the setup vehicle speed is currently stored (S20; YES), and a situation where no setup vehicle speed is currently stored (S20; NO).

In the vehicle control device according to this embodiment, when a driver manipulates the resume switch 24g during the standby state of the driving support mode, processing is executed in different manners depending on whether or not the setup vehicle speed is currently stored in the memory 11, so as to set an appropriate value as the setup vehicle speed. Therefore, the vehicle control device according to this embodiment makes it possible improve safety and manipulatability by the driver, during returning to the active state.

In the vehicle control device according to this embodiment, in response to manipulation of the resume switch (S21, S28) during the standby state, the control part (ECU 10) is operable to maintain the currently-stored setup vehicle speed (S22) in the situation where the setup vehicle speed is currently stored (S20; YES), and store the speed limit acquired by the speed limit recognition part as the setup vehicle speed (S29) in the situation where no setup vehicle speed is currently stored (S20; NO). According to this feature, in the situation where the setup vehicle speed is stored in the memory 11 (see FIG. 4), the currently-stored setup vehicle speed (ECU 10) is maintained, and, in the situation where no setup vehicle speed has yet been stored in the memory 11 (see FIG. 5), the setup vehicle speed is set by the speed limit. That is, when the resume switch 24g is manipulated during the standby state, either one of the currently-stored or existing setup vehicle speed recognized by the driver and the speed limit assigned to the traveling road 3 is set as the setup vehicle speed. Therefore, it becomes possible to improve safety and manipulatability by the driver, during returning to the active state.

In the vehicle control device according to this embodiment, the control part (ECU 10) is further operable to switch the driving support mode from the standby state to the active state (S22) when the control part (ECU 10) operates to maintain the setup vehicle speed currently stored by the control part in response to manipulation of the resume switch 24g during the standby state (S21). According to this feature, the driver can use the resume switch 24g to switch the driving support mode from the standby state to the active state, as with conventional systems.

In the vehicle control device according to this embodiment, the control part (ECU 10) is further operable to maintain the driving support mode in the standby state (S29) when the control part (ECU 10) operates to store the speed limit acquired by the speed limit recognition part as the setup vehicle speed in response to manipulation of the resume switch 24g during the standby state (S28). According to this feature, when the resume switch 24g is manipulated during the standby state and in the situation where no setup vehicle speed has yet been stored in the memory 11, setting of the setup vehicle speed is first performed using the speed limit. Thus, the driver can visually check the setup vehicle speed on the setup vehicle speed display field 28b. Then, the driver can re-manipulates the resume switch 24g to return the driving support mode to the active state.

In the vehicle control device according to this embodiment, the control part (ECU 10) is operable to switch the driving support mode from the standby state to the active state (S22) in response to re-manipulation of the resume switch 24g (S21) when the control part (ECU 10) operates to store the speed limit acquired by the speed limit recognition part as the setup vehicle speed (S29) in response to manipulation of the resume switch 24g during the standby state (S28). According to this feature, even in the situation where no setup vehicle speed has yet been stored in the memory 11 (S20; NO), the driver can manipulate the resume switch 24g twice at a maximum (S28, S21) to return the driving support mode to the active state.

In the vehicle control device according to this embodiment, the manipulation unit comprises a cancel switch 24d for switching the driving support mode from the active state to the standby state during execution of the driving support mode, and wherein the control part (ECU 10) is operable to store the speed limit acquired by the speed limit recognition part (ECU 10, navigation device 26) as the setup vehicle speed (S15) in response to manipulation of the cancel switch 24d during the active state (S13).

According to this feature, the driver can manipulate the cancel switch 24d to switch the driving support mode from the active state to the standby state. In this process, the speed limit assigned to the traveling road 3 is stored as the setup vehicle speed. Thus, when the driving support mode is returned to the active state, the vehicle speed control in the driving support mode is executed by using the speed limit assigned to the traveling road as the setup vehicle speed. Therefore, according to this feature, it becomes possible to improve safety and manipulatability by the driver, during returning to the active state, without any need to re-set the setup vehicle speed in conformity to the traveling road 3.

In the vehicle control device according to this embodiment, the manipulation unit 24 comprises the vehicle speed setting switch (24e, 24f) for setting the setup vehicle speed, wherein the control part (ECU 10) is operable to switch the driving support mode from the standby state to the active state (S22) in response to manipulation of the vehicle speed setting switch (24e, 24f) until elapse of a given time period (e.g., 3 to 10 seconds) (S23; YES) after the speed limit acquired by the speed limit recognition part is stored as the setup vehicle speed.

According to this feature, until the elapse of the given time period after the driving support mode is switched from the active state to the standby state by the manipulation of the cancel switch 24d (or after the acquired speed limit is stored as the setup vehicle speed), the vehicle speed setting switch (24e, 24f) can be used for returning the driving support mode to the active state as with the resume switch 24g, instead of for setting the setup vehicle speed.

In the vehicle control device according to this embodiment, the control part (ECU 10) is operable to change the currently-stored setup vehicle speed (S26) in response to manipulation of the vehicle speed setting switch (24e, 24f) after the elapse of the given time period (S23; NO). According to this feature, after the elapse of the given time, the vehicle speed setting switch (24e, 24f) can be used for achieving an original function thereof, i.e., a function of setting the setup vehicle speed.

In the vehicle control device according to this embodiment, the control part (ECU 10) is operable to switch the driving support mode to the active state so as to execute the vehicle speed control using the setup vehicle speed currently stored (S22) in response to manipulation of the resume switch 24g (S21) during the standby state, and the control part (ECU 10) is operable to store the speed limit acquired by the speed limit recognition part as the setup vehicle speed (S19) in response to manipulation of the resume switch 24g (S16) during the active state, and to store the speed limit acquired by the speed limit recognition part as the setup vehicle speed (S29) in response to manipulation of the resume switch 24g (S28) during the standby state in a situation where no setup vehicle speed is currently stored (S20; NO).

According to this feature, when the driver manipulates the resume switch 24g during the standby state of the driving support mode, the driving support mode is resumed or restarted (returned to the active state), while using the setup vehicle speed currently stored in the memory 11, as with conventional systems. Further, according to this feature, depending on actual conditions, different controls are executed in response to manipulation of the resume switch 24g. Specifically, during the active state, in place of the setup vehicle speed currently stored by the control part (ECU 10), the speed limit is used as the setup vehicle speed, and the active state is maintained. Further, during the standby state and in the situation where no setup vehicle speed has yet been stored in the memory 11, the speed limit is stored in the memory 11 as the setup vehicle speed. As above, according to this feature, depending on the activation state (the active or standby state) of the driving support mode, and the presence or absence of the setup vehicle speed currently stored in the memory 11, the driver can easily set the setup vehicle speed in conformity to the speed limit assigned to the traveling road, by means of the resume switch 24g. This makes it possible to improve safety and manipulatability by the driver during the driving support mode.

In the vehicle control device according to this embodiment, when the vehicle 1 is stopped by the vehicle speed control in the active state (S17; YES), the control part (ECU 10) is operable to maintain the stopped state until the resume switch 24g is manipulated, and to permit the vehicle 1 to be started (S18) in response to the manipulation of the resume switch 24g. According to this feature, when the vehicle 1 is automatically stopped by the vehicle speed control in the driving support mode, the vehicle 1 is allowed to be started in response to the manipulation of the resume switch 24g indicative of driver's intention to start the vehicle 1.

### LIST OF REFERENCE SIGNS

1: vehicle
10: control unit
100: vehicle control device

1. A vehicle control device comprising:
a control part operable to execute vehicle speed control for a vehicle according to a setup vehicle speed being stored, during execution of a driving support mode;
a manipulation unit manipulatable by a driver; and
a speed limit recognition part operable to acquire a speed limit assigned to a traveling road,
wherein the driving support mode includes an active state in which the vehicle speed control is executed, and a standby state in which the vehicle speed control is temporarily disabled,
wherein the manipulation unit comprises a resume switch, and
wherein, in response to manipulation of the resume switch during the standby state, the control part is operable to select and store a vehicle speed value as the setup vehicle speed in different manners between a situation where the setup vehicle speed is currently stored and a situation where no setup vehicle speed is currently stored.

2. The vehicle control device as recited in claim 1, wherein, in response to manipulation of the resume switch during the standby state, the control part is operable to maintain the currently-stored setup vehicle speed in the situation where the setup vehicle speed is currently stored, and store the speed limit acquired by the speed limit recognition part as the setup vehicle speed in the situation where no setup vehicle speed is currently stored.

3. The vehicle control device as recited in claim 2, wherein the control part is further operable to switch the driving support mode from the standby state to the active state when the control part operates to maintain the currently-stored setup vehicle speed in response to manipulation of the resume switch during the standby state.

4. The vehicle control device as recited in claim 2, wherein the control part is further operable to maintain the driving support mode in the standby state when the control part operates to store the speed limit acquired by the speed limit recognition part as the setup vehicle speed in response to manipulation of the resume switch during the standby state.

5. The vehicle control device as recited in claim 1, wherein the manipulation unit comprises a cancel switch for switching the driving support mode from the active state to the standby state during execution of the driving support mode, and
wherein the control part is operable to store the speed limit acquired by the speed limit recognition part as the setup vehicle speed in response to manipulation of the cancel switch during the active state.

6. The vehicle control device as recited in claim 5, wherein the manipulation unit comprises a vehicle speed setting switch for setting the setup vehicle speed, and
wherein the control part is operable to switch the driving support mode from the standby state to the active state in response to manipulation of the vehicle speed setting switch until elapse of a given time period after the speed limit acquired by the speed limit recognition part is stored as the setup vehicle speed.

7. The vehicle control device as recited in claim 6, wherein the control part is operable to change the currently-stored setup vehicle speed in response to manipulation of the vehicle speed setting switch after the elapse of the given time period.

8. The vehicle control device as recited in claim 1, wherein the control part is operable to switch the driving support mode to the active state so as to execute the vehicle speed control using the setup vehicle speed currently stored in response to manipulation of the resume switch during the standby state, and
wherein the control part is operable to store the speed limit acquired by the speed limit recognition part as the setup vehicle speed in response to manipulation of the resume switch during the active state, and to store the speed limit acquired by the speed limit recognition part as the setup vehicle speed in response to manipulation of the resume switch during the standby state in a situation where no setup vehicle speed is currently stored.

9. The vehicle control device as recited in claim 8, wherein, when the vehicle is stopped by the vehicle speed control in the active state, the control part is operable to maintain the stopped state until the resume switch is manipulated, and to permit the vehicle to be started in response to the manipulation of the resume switch.

10. A vehicle control device comprising:
a control unit configured to execute vehicle speed control for a vehicle according to a setup vehicle speed being stored during execution of a driving support mode, and to acquire a speed limit assigned to a traveling road; and
a manipulation unit manipulatable by a driver,
wherein the driving support mode includes an active state in which the vehicle speed control is executed, and a standby state in which the vehicle speed control is temporarily disabled,
wherein the manipulation unit comprises a resume switch, and
wherein, in response to manipulation of the resume switch during the standby state, the control unit is operable to select and store a vehicle speed value as the setup vehicle speed in different manners between a situation where the setup vehicle speed is currently stored, and a situation where no setup vehicle speed is currently stored.
